(19) United States
(12) Patent Application Publication
(10) Pub. No.: US 2007/0171031 A1
(43) Pub. Date: Jul. 26, 2007

(54) Portable flashing trailer safety lighting system

(76) Inventor: Steve Hastings, Los Altos, CA (US)

Correspondence Address: ERIC HANSCOM, 7395 PORTAGE WAY, CARLSBAD, CA, 92011, US

(21) Appl. No.: 11/338,201

(22) Filed: Jan. 24, 2006

(51) Int. Cl. G08B 21/00

(52) U.S. Cl. 340/431

(57) ABSTRACT

A portable flashing trailer safety lighting system, consisting of a control box either containing a battery or using the existing battery on the towed vehicle to be used in the event rear lighting on a trailer is not available. A wiring harness coming from the control box with a toggle switch connects to a conventional trailer lighting harness plug when it is removed from the towing vehicle, providing power to flash the tail lights or running lights or both. By activating the toggle switch on the control box, the lights of the trailer will flash. An LED light bar is supplied with the system to supply lights when the existing lights on the trailer are inoperable.

PARTS LIST

| 10A | Self-powered, trailer safety lighting system |
|---|---|
| 10B | Self-powered, trailer safety lighting system |
| 10C | Self-powered, trailer safety lighting system |
| 12 | Trailer front hitch portion |
| 14 | Straps |
| 16 | Trailer safety lighting system wiring harness |
| 18 | Trailer safety lighting system female plug |
| 20 | Trailer wiring harness |
| 22 | Trailer wiring harness male plug |
| 24 | Toggle switch |
| 26 | Box upper surface |
| 28 | Electrical component container or box |
| 30 | Battery |
| 32 | Commercially available flasher circuit |
| 34 | Wire between Battery & flasher circuit |
| 36 | Wire |
| 38 | Wire |
| 40 | Flashing circuit |
| 42 | Existing trailer battery |
| 44 | Existing trailer battery terminals |
| 46 | Terminal connectors |
| 48 | Power wiring harness |
| 50 | Control box |
| 52 | Toggle switch |
| 54 | Safety lighting system wiring harness |
| 56 | Trailer safety lighting system female plug |
| 58 | Trailer plug |
| 60 | Trailer wiring harness |
| 62 | Wire |
| 64 | Cigarette lighter plug end |
| 66 | Wiring junction |
| 68 | Light bar |
| 70 | Light bar plug |
| 72 | Flexible wire |
| 74 | Light emitting diodes |
| 76 | |
| 78 | Box |
| 80 | Toggle switch |
| 82 | Light bar |
| 84 | Flexible wires |
| 86 | Back of the box |
| 88 | Mounting bracket |
| 90 | Holes |
| 99 | In-line fuse |

### FIELD OF THE INVENTION

This invention deals with a small, portable, flashing trailer safety lighting system that can be quickly mounted to a towed vehicle to supply temporary warning lights for approaching vehicles. A wide variety of reflective devices exist to place behind a towed vehicle that has been inadvertently stopped along the side of the roadway, but presently there is no means to supply temporary power to the tail or running lights when the towed vehicle has been disconnected from the towing vehicle. More specifically this device discloses a portable, self-powered unit or a unit that can quickly be connected to the existing battery of a towed vehicle to supply temporary power to the stoplights or running lights or both. The units will have the option of having a light bar that can be attached at the rear of the towed vehicle if the lights are inoperable.

### BACKGROUND OF THE INVENTION

There is a growing need for inexpensive aftermarket automotive safety products for small, towed vehicles. A wide variety of towed vehicles are presently on the highway today, from utility maintenance trailers to house trailers, boat trailers and car carriers towed by recreational vehicles—indeed, several commercial operations such as U-Haul have entire fleets of rental trailers available for people needing to move small amounts of items. The lighting of trailers, however, has been the proverbial weak link in the chain with respect to towing a trailer for many years. Most trailers are wired with a 4-, 5-, 6- or 7-wire plug which mates with a counterpart from the towing vehicle, with all the power coming from the towing vehicle. Thus, should the towing vehicle lose power, as would be the case when it runs out of gas or loses an alternator, the vehicle battery is the only thing standing between a lighted trailer and an unlighted trailer. Additionally, there are times when the trailer or other towed vehicle must be left on the side of the road, or towed without lights so the driver of the towing vehicle can seek maintenance assistance. If the towing vehicle has lost power or has a dead battery, there is no way for the driver to supply power to the tail or running lights of the towed vehicle with the only option being reflective devices or flares. On a dark road, an unlighted vehicle presents a great hazard to oncoming drivers, and has been the cause of many serious accidents and fatalities.

Conventional internal lighting systems with batteries housed in towed vehicles such as house trailers and boat trailers do not provide a means to connect to the tail or running lights when the towed vehicle is disconnected from the towing vehicle, thus even if the towing vehicle has adequate power to light the trailer lights, should the driver need to disconnect the trailer from the towing vehicle, the trailer lights will not function.

The inventor has found that by supplying a small portable unit with a battery enclosed or using the existing battery in the towed vehicle, his invention can be plugged into the lighting harness of the towed vehicle, thereby supplying power to the brake or running lights or both. An additional flasher circuit within the device will minimize the use of the battery when the device is turned on by a manual toggle switch to energize the trailer safety lighting system. There is an inline fuse to provide circuit protection. Without a direct connection to the towing vehicle electrical system, the battery of the device will have to be maintained by the driver of the towed vehicle. This can be done with a conventional battery trickle charger plugged into 110 volt house current or connected to a solar panel battery charger.

Boat trailers, particularly those used in salt water, present an additional problem: if water gets into the wiring of a trailer harness, particularly to the junction between the plug from the trailer wiring harness and the towing vehicle wiring harness it can disrupt the connection and render the trailer lights nonfunctional. This is especially common where this junction hangs below the receiver such that it is immersed in water every time the boat is unloaded or loaded back onto the trailer. Thus, it is very common on boat trailers that the lights work when the boat is put in the water and do not work when the boat is removed from the water.

In the case of boat trailers and other towed vehicles where there are frequent problems maintaining a connection with the towing vehicle, the invention provides a portable self- powered, flashing trailer safety lighting system with the addition of a light bar that can be used as a temporary method of moving vehicles safely. Presently some permanently mounted systems exist to supply power to the lights of parked trailer units, but these systems have been designed for large transport trailers where a wide variety of connections are made, including the recharging of the battery of the towed vehicle by the towing vehicle's electrical system. While the prior patents and commercial devices found in the prior art have been successful to a certain extent on large commercial vehicles, it is nonetheless clear that substantial room exists for affecting an advance in the art, which overcomes these shortcomings in a practical and efficient manner.

Of course, batteries, switches, and electric circuitry have been known and used for many years and most people are familiar with flashlights and other types of auxiliary light devices. Connectable jacks for electric circuits are of course also universally known, even on low-current extension lights, which may be plugged into a vehicle's cigarette lighter which serves as a jack, and these and other factors of prior art knowledge and prior art devices are not novel. However, the existence of such articles and knowledge of the prior art is not only conceded, it is emphasized for it is with similarities to long-known components and concepts that the present inventive concepts are built. The construction and operation of the device is significantly different from the components and operations of all the articles of the prior art, thus the inventive significance of the present concepts are emphasized, and the nature of the concept and their results can perhaps be easier understood.

Even further indicating the inventive nature of the present concepts is the result of a Preliminary Patentability Search made from the files of the U.S. Patent Office, after this invention was conceived, and during the course of considering the desire and likelihood of patent protection. The search produced the following U.S. Patents.

### REFERENCES SITED

U.S. Pat. No. 4,593,264 to Edgar R. Engle describes a dual trailer hitch warning system for use with a ball and socket trailer hitch including an electrically operated alarm system for signaling a loose coupling of the socket member on the ball member. A switch is mounted within the ball member, which energizes an alarm relay circuit when the ball switch operates due to a loose coupling to complete an alarm circuit between the automobile battery and the horn. The warning system also includes a tampering relay circuit adapted to provide an alarm signal if an attempt is made to disengage or short out the alarm circuit or if the socket and ball member are deliberately uncoupled.

This patent describes an efficient system of notifying the driver of a towed vehicle that there is a problem with the connection between the two units and the capability of having a warning system if an attempt is made to disconnect the trailer without the knowledge of the owner. It does not, however, function as a portable warning light system for the towed vehicle if it must be towed without lights or left on the side of the road.

U.S. Pat. No. 4,743,888 to Wolfgang, Hilpert et al. teaches a detection device for a trailer coupled onto a tractor/towing vehicle which incorporates the rear or brake or license plate illuminating lights of the trailer and by corresponding combinations of the signal applied at a logic element, an output signal for triggering the indication “trailer coupled” is achieved.

This patent describes a device permanently attached to large transport truck and trailer units to notify the drivers of the truck that trailer has been coupled with the truck. This patent does not employ a means to activate the lights of the trailer unit and does not supply power in the trailer for this purpose.

U.S. Pat. No. 4,857,807 to Charles W. Hargis discloses an auxiliary light module for vehicles, giving battery back-up provisions, particularly useful for vehicles in which the pulling tractor electrically energizes the light systems of the pulled trailer by a connector strap or harness for interconnecting the tractors output jack and the trailer's input jack. The module provides a device conveniently connectable to both, the tractor and trailer by jacking to the jacks now used by the jacks of such connector strap or harness. The module includes a battery, a switch, and circuitry for providing the electrical energization of the trailer's running lights and tail lights when the semi is stopped, and whether or not the tractor remains connected to the trailer providing the safety of the warning lights being lit, thereby avoiding a drain on the tractor's own battery.

This patent discloses a similar application to the proposed patent of supplying a battery in the trailer unit of a large transport truck and trailer. It can activate and flash the lights on the trailer when it is removed from the truck. The battery is connected through an extensive harness system to be charged when connected to the truck. This system must be permanently mounted in the trailer and could not be easily moved to another trailer quickly in the case of an emergency. This unit as disclosed could neither be easily adapted to a large variety of small utility and recreational trailers, nor have the option of an added light bar when the lights on the trailer are inoperable. It could not be easily stored in the glove box or trunk of a passenger car or light duty truck, thereby rendering it less than optimum for uses outside of large tractor/trailer rigs.

U.S. Pat. No. 5,434,552 to Glenn L. Ems additionally describes a trailer hitch security system that has a first audible alarm to alert the driver of a towing vehicle of a loose connection with the trailer, and of a loose connection between the ball of the trailer hitch and the towing vehicle's frame. The system also has two visual indicators alerting the driver of the state of the coupling between the trailer and the vehicle. A second audible alarm is automatically activated if the vehicle's ignition is turned off and an unauthorized removal of the trailer is attempted. The second audible alarm is loud and intermittent, thus alerting the driver of unauthorized unhitching, or theft of the trailer. The loud alarm may be turned off only from within the cab of the vehicle, as returning the trailer to the towing vehicle's ball will not deactivate it. The second audible alarm is tied to a timer, which limits the sounding of the second audible alarm to a preset time interval.

This patent describes another trailer hitch security system with loose connection and theft-protection alarms. The activation switch is in the towing ball and this system is housed in the towing vehicle, and would not be capable of activating the lights on the trailer when it has been removed from the towing vehicle.

U.S. Pat. No. 5,775,712 to Richard L. Link tells of an apparatus for providing emergency actuation of lights on a trailer. The apparatus comprises of an electrical input connector for electrically connecting the apparatus with the plug of a towing vehicle lighting pigtail, an electrical output connector for electrically connecting the apparatus with an electrical connector of a trailer lighting harness, a battery, a battery charging circuit operable to receive power front a towing vehicle through the electrical input connector and to charge the battery, and a control circuit comprising a flasher and a solenoid switch. The control circuit is operable in a first mode, to electrically connect the towing vehicle lighting pigtail with the trailer lighting harness with a towing vehicle lighting harness and operable, in a second mode, to connect the battery of the apparatus through the flasher to the trailer lighting harness. The solenoid switch switches the control circuit from the first mode to the second mode when no power is delivered to the electrical input connector. The control circuit may include an actuation switch. When the apparatus is connected to the towing vehicle's lighting pigtail and actuated by the switch with the lights of the towing vehicle turned off, the apparatus will cause the trailer lights to flash until the towing vehicle lights are actuated. The trailer lights will thereafter be controlled by the lighting controls in the towing vehicle until such time as the towing vehicle's lighting pigtail stops delivering power to the electrical input connector of the apparatus.

This patent is directed to back-up, fail-safe emergency lighting apparatus for use on large towed vehicles. The apparatus is permanently connected electrically to the trailer lighting circuit between the towing vehicle and the towed vehicle lights and upon interruption or disruption of the lighting power from the towing vehicle, the apparatus is operable to energize the marker lights on the towed vehicle. It can activate and flash the lights on the towed vehicle when it is removed from the truck. The battery is connected through an extensive harness system to be charged when connected to the truck. This system must be permanently mounted in the trailer and could not be easily moved to another trailer quickly in the case of an emergency. This unit as disclosed could not be easily adapted to a large variety of small utility and recreational trailers or be used by one towing vehicle with several different trailers.

U.S. Pat. No. 6,879,251 B2 to William J. Robbins illustrates an electrical input signal from a vehicle's safety system that actuates an electronic switch to close a by-pass circuit that circumvents a manual control for hazard lights. As a result, the hazard lights are automatically activated in response to the input signal upon actuation from the safety system and without manual intervention.

This patent tells of a system to automatically activate the hazard lights rather than manually. This patent refers to a single operation and does not make reference to towed vehicles.

None of these previous efforts, however, provides the benefits attendant with the present invention. The present invention achieves its intended purposes, objects and advantages over the prior art devices through a new, useful and unobvious combination of method steps and component elements, with the use of a minimum number of functioning parts, at a reasonable cost to manufacture, and by employing readily available materials.

Thus, there has existed a long-felt need for a portable, self-powered unit or a unit that can quickly be connected to the existing battery of a towed vehicle to supply temporary power to the stop lights or running lights or both.

The current invention provides just such a solution by having a means by which a user of a trailer or other towed vehicle can quickly obtain working lights on his or her trailer. The invention provides several iterations including a removable battery which connects directly to the trailer wiring harness, a unit which connects the trailer lights to a pre- existing battery on the trailer, or to a source of power in the towed vehicle such as a cigarette lighter, and a portable unit with a light bar which can be quickly and removably mounted to the trailer to provide flashing light or steady light in a variety of locations.

### THE OBJECTS OF THE INVENTION

It is a primary object of this invention to connect a unique trailer safety lighting system to the taillights of private utility and recreational trailers.

Another object of this invention is to supply a self-powered, trailer safety lighting system that will plug into the wiring harness of private utility and recreational trailers.

Another object of this invention is to supply a self-powered trailer lighting system with a flasher relay to cause the tail lights, running lights or both to flash on and off in the case of an emergency. Another object of this invention is to supply a portable self-powered, flashing trailer safety lighting system that can easily be moved from one pair of vehicles to a second pair of vehicles or from one towing vehicle to a number of different towed vehicles.

Another object of this invention is to supply a portable self-powered, flashing trailer safety lighting system that will optionally connect with a light bar using LED's that attaches to the rear of the vehicle if the existing lights are inoperable.

An additional object of this invention is to provide a means by which a light bar, independent of any towing vehicle power supply, can be attached at a number of locations throughout a towed trailer.

Still another object of this invention is to have an alternate embodiment of the trailer safety lighting system that will plug into a lighter outlet or connect to the existing battery of a recreational/utility towed vehicle for power and connect to the wiring harness flashing the tail lights, running lights or both.

A further object of this invention is to have an alternate embodiment of the trailer safety lighting system that will plug into a lighter outlet or connect to the existing battery of a recreational towed vehicle for power and optionally connect with a light bar using an LED light source to attach to the rear of the vehicle if the existing lights are inoperable.

Yet another object of this invention is to supply a portable self-powered, flashing trailer safety lighting system that can be attached to any towed vehicle without lights that must be moved in an emergency situation.

A final object of this invention is to make the highways safer by supplying a means of adequate lighting vehicles that in an emergency situation must be parked or left on the side of the road.

The foregoing has outlined some of the more pertinent objects of the invention. These objects should be construed to be merely illustrative of some of the features that are more prominent and applications of the intended invention.

In this respect, before explaining at least one embodiment of the invention in detail it is to be understood that the invention is not limited in its application to the details of construction and to the arrangement, of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent construction insofar as they do not depart from the spirit and scope of the present invention.

### SUMMARY OF THE INVENTION

The invention is defined by the appended claims with the specific embodiments shown in the attached drawings. Briefly stated, the present invention contemplates a novel method of a dependable supply of lighting to a trailer or other towed vehicle that has been disabled on the side of the road or when the rear lights are inoperable and the vehicle must be moved on the roadway. The preferred embodiment of the device, the portable battery operated flashing trailer safety lighting system, consists of a control box being a sealed container housing one or more batteries, and a flasher circuit with an on and off toggle switch. A wiring harness coming from the control box connects to a conventional trailer lighting plug. A variety of trailer lighting plugs exists and will work on this device and will be covered within the scope of this patent. When a trailer's lights are inoperable the plug on the wiring harness from the control box is attached to the plug of the wiring harness of the trailer that was initially connected to the towing vehicle. By activating the toggle switch on the control box, the lights of the trailer will flash on and off.

An alternate embodiment of the device, a portable flashing trailer safety lighting system consists of a control box being a sealed container with a flasher circuit with an on and off toggle switch. A wiring harness coming from the control box connects to a conventional trailer lighting plug. A second wiring harness coming from the control box splits into two lines, one to a cigarette lighter plug and the other to battery terminal connectors. The lighter plug and battery terminal connectors are a means to connect to a cigarette lighter outlet or the battery in a recreational vehicle. When a trailer's lights are inoperable the plug on the wiring harness from the control box is attached to the plug of the wiring harness of the trailer that was initially connected to the towing vehicle and either the cigarette lighter plug is connected to an outlet or the battery terminal connectors are connected to a 12 volt battery and protected by an in-line fuse. By activating the toggle switch on the control box, the lights of the trailer will flash on and off.

Both the portable battery operated flashing trailer safety lighting system and the portable flashing trailer safety lighting system may be coupled to the LED light bar incorporated in both systems as a means to furnish lights if there is no working lights at the rear of the vehicle.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the detailed description, serve to explain the principles of this invention.

FIG. 1 depicts a perspective view of the front hitch portion of a typical utility or recreational trailer with the self-powered, trailer safety lighting system attached and plugged into the existing wiring harness of the vehicle.

FIG. 2 depicts a schematic of the self-powered, trailer safety lighting system.

FIG. 3 depicts a perspective view of the front hitch portion of a typical utility or recreational trailer with the trailer safety lighting system that will plug into a lighter outlet or connect to the existing battery of a recreational towed vehicle for power and connect to the wiring harness.

FIG. 4 depicts a schematic of the trailer safety lighting system that will plug into a lighter outlet or connect to the existing battery.

FIG. 5 depicts a schematic of the self-powered, trailer safety lighting system with the optional light bar.

FIG. 6 depicts a schematic of the trailer safety lighting system with the optional light bar.

FIG. 7 depicts a perspective view of a fully self-contained lighting device, which can be quickly attached and removed from the trailer.

### DETAILED DESCRIPTION OF THE PREFERRED EMBODIMENTS

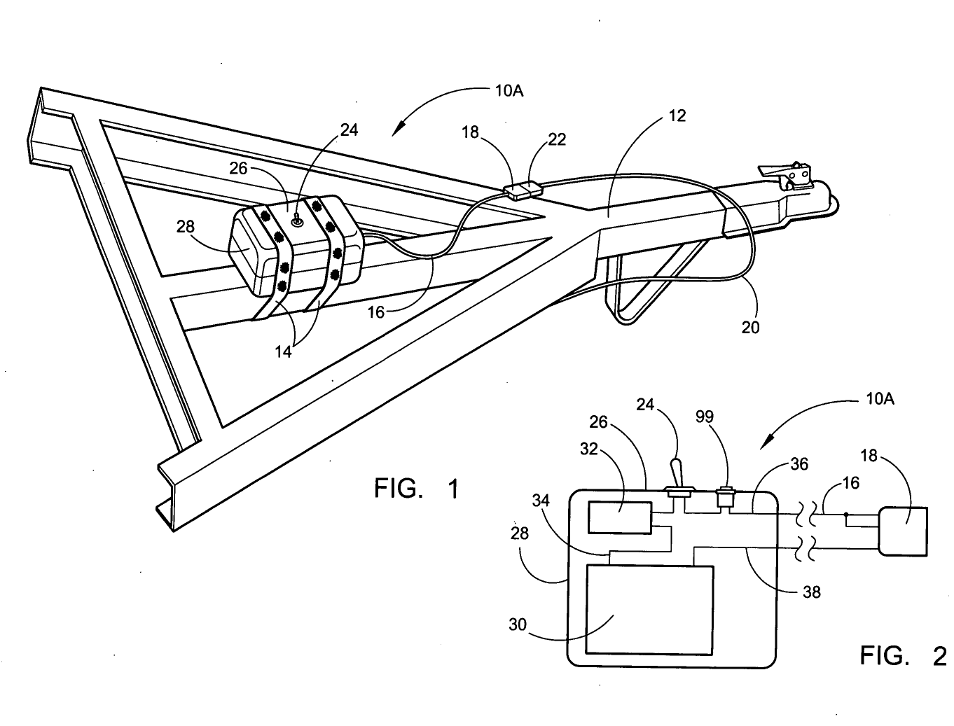

Details of the invention, and of preferred embodiments thereof, will be further understood upon reference to the drawings, wherein FIG. 1 depicts the self-powered, trailer safety lighting system (10A) temporarily attached to the front hitch portion (12) of a typical utility or recreational trailer by the means of straps (14). FIG. 1 depicts a perspective view of the front hitch portion (12) of a typical utility or recreational trailer with the self-powered, trailer safety lighting system (10A) attached by the means of a conventional trailer safety lighting system wiring harness (16) female plug (18) into the existing trailer wiring harness (20) male plug (22) of the towed vehicle. A variety of attachment means may be used to temporarily attach the self-powered, trailer safety lighting system (10A) to the front hitch portion (12) although it need not be attached at all, being that it is only used under normal circumstances when the vehicle is stationary. A toggle switch (24) is shown on the upper surface (26) of the electrical component container or box (28) to be used to activate the tail lights and/or running lights of the vehicle. When the user desires to power on the lights of the trailer, he/she attaches the box (28), which contains a battery (not shown in this figure) to the trailer with one or more straps (14), then connects the trailer safety lighting system wiring harness (16) female plug (18) into the male plug (22) of the trailer wiring harness (20), thereby allowing current from the battery to flow through the trailer safety lighting system wiring harness (16), through the female plug (18) to the male plug (22) of the trailer wiring harness (20), to the trailer lights (not shown in this figure). Thus, when the user of the invention detaches the trailer from the towing vehicle, he/she can keep the trailer lights functioning with energy from the battery. It should be noted that solar batteries or a solar charger connected to the box are part of one iteration of this invention, by which a user can leave the box (28) attached to the trailer in a sunny location such that the battery will remain charged or in cases where the trailer remains on the side of the road for more than one day.

FIG. 2 depicts a schematic of the self-powered, trailer safety lighting system (10A). The electrical component container or box (28) has an in-line fuse (99) and contains a battery (30), a commercially available flasher circuit (32), connected to the battery (30) by a wire (34), a toggle switch (24) on the top surface (26) of the box (28), a wire (36) connecting the toggle switch (24), through the in-line fuse (99), to the safety lighting system wiring harness (16), female plug (18), and another wire (38) completing the circuit back to the battery (30). Thus, by flipping the toggle switch (24) a user can turn on and off the trailer lights without having to rely on power from the towing vehicle.

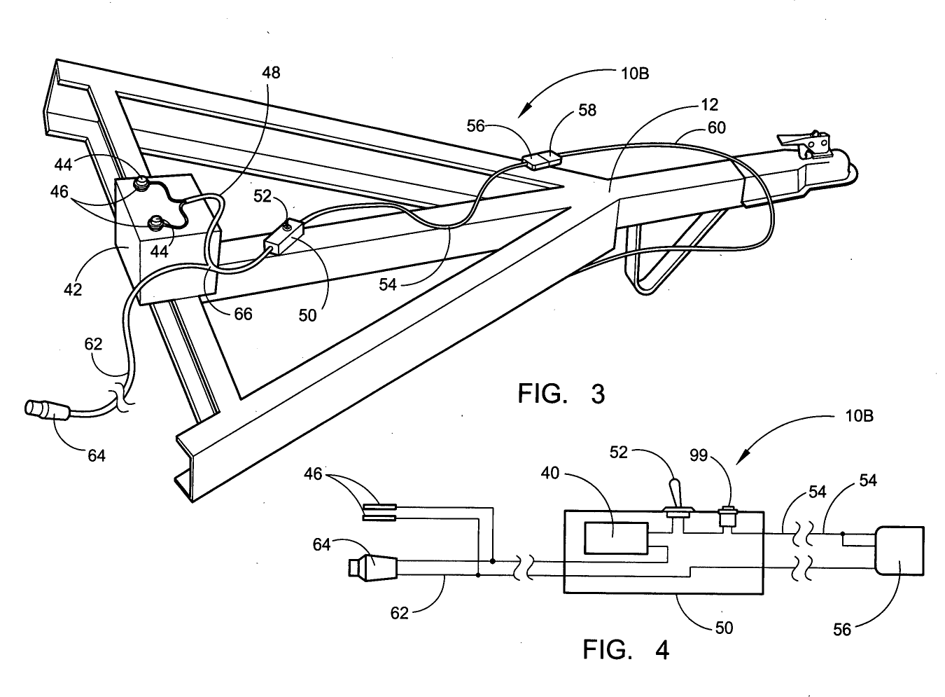

FIG. 3 depicts a perspective view of the front hitch portion of a typical utility or recreational trailer with the trailer safety lighting system (10B) that will plug into a lighter outlet or connect to the existing battery of a recreational towed vehicle for power and connect to the wiring harness. FIG. 4 depicts the schematic of the trailer safety lighting system (10B) that will plug into a lighter outlet or connect to the existing battery as illustrated by FIG. 3 additionally depicting the flashing circuit (40). A battery (42) provides power through terminals (44) to terminal connectors (such as alligator clips) (46) which connect via a power wiring harness (48) to a control box (50), which contains a toggle switch (52) by which the user turns on and off the lighting system. Power allowed to pass through the toggle switch (52) passes though the trailer safety lighting system wiring harness (54) to the female plug (56), which mates with a trailer male plug (58) and passes current through the trailer wiring harness (60) to one or more lights on the trailer (not visible in this figure). An in-line fuse (99) protects the circuit. As an alternative or additional source of power, a second wire (62) terminating in a plug end (64) which can plug into a cigarette lighter in the towing vehicle. The second wire (62) merges with the main current from the battery (42) at a junction point (66).

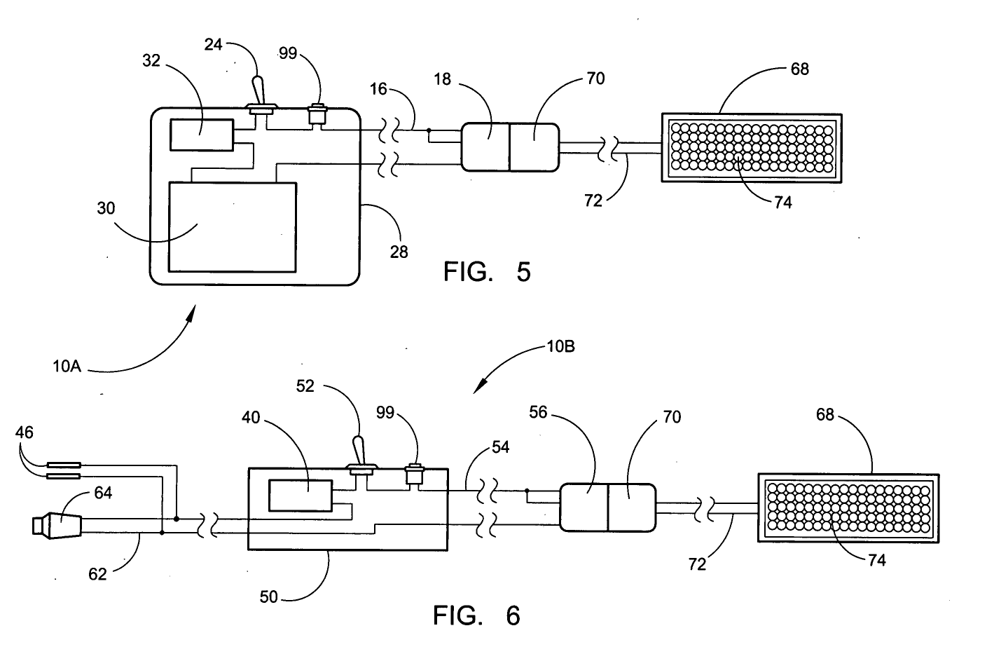

FIG. 5 depicts a schematic of the self-powered, trailer safety lighting system (10A) with the optional light bar (68). Inside an electrical component container or box (28) is a battery (30) and commercially available flasher circuit (32). An in-line fuse (99) protects the circuit. A toggle switch (24) may be turned on or off to allow current from the battery (30) to the box plug (18) which mates with a light bar plug (70), which is connected by a flexible wire (72) to a light bar (68), with a series of one or more LED's (light emitting diodes) (74). The light bar can be mounted in a variety of places due to the flexible wire (72), which can be made in varying lengths.

FIG. 6 depicts a schematic of the trailer safety lighting system (1OB) with the optional light bar (68). Inside a control box (50) is a commercially available flasher circuit (40) and a toggle switch (52) which may be turned on or off to allow current from the battery terminal connectors (46) to go through the control box (50). An in-line fuse (99) protects the circuit. The control box (50) with the wiring harness (54) attached to the trailer safety lighting system female plug (56), mates with a light bar plug (70), that is connected by a flexible wire (72) to a light bar (68), having a series of one or more LED's (light emitting diodes) (74). The light bar (68) can be mounted in a variety of places due to the flexible wire (72), which can be made in varying lengths. An alternative or additional source of power is a plug end (64), which can be plugged into the cigarette lighter/power plug in a towing vehicle.

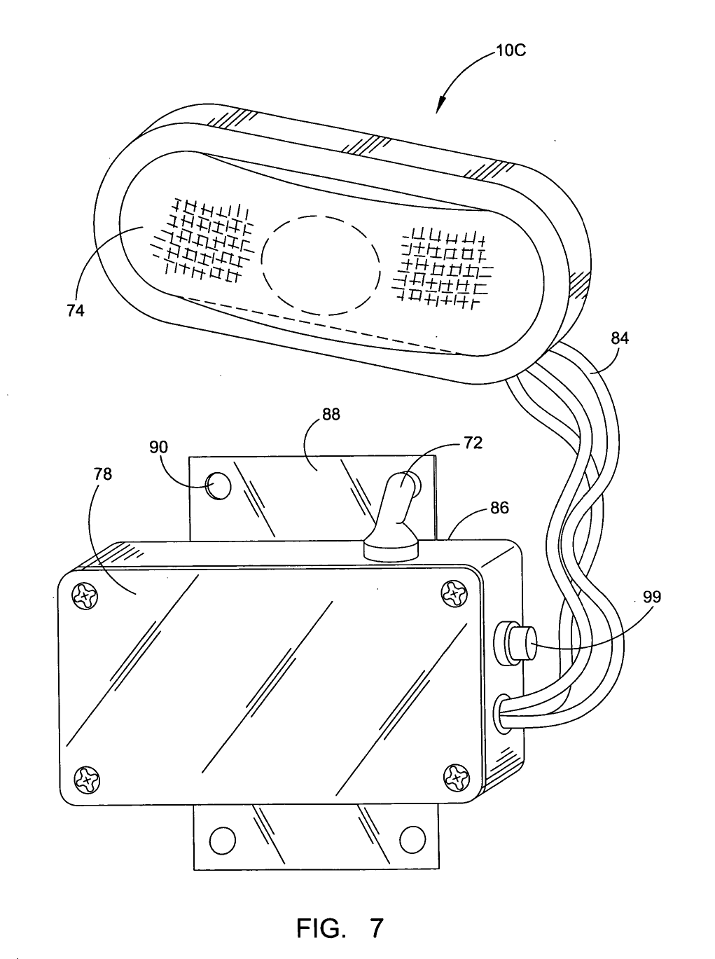

FIG. 7 depicts a perspective view of a fully self-contained lighting device (10C) which can be quickly attached and removed from the trailer. The box (78) contains a battery (not shown in this figure). On the side of the box (78) there is an in-line fuse (99) and on the top of the box there is a toggle switch (72) which turns on and off the current from the battery to the light bar (74). The actual locations of the toggle switch and fuse can be varied, and are illustrated here in merely one of the many configurations possible. The light bar (74) is attached to the box (78) by a series of flexible wires (84) which can be used to position the light bar (74) at a variety of desired locations. The light bar (74) can attach to various parts of the trailer, boat, or whatever is being towed through magnets, hooks, hook and loop fasteners, or other commercially known means. On the back of the box (86) is a mounting bracket (88) with holes (90), which allows the box (78) to be quickly mounted to the rear bumper of the trailer or another convenient location through straps or bungee cords going through the holes (90), or U-shaped bolts which fit around the bumper or other piece of the trailer and have butterfly nuts or some other type of quick-release nut such that the lighting device can be removed quickly and easily.

The self-powered, trailer safety lighting system 10A, 10B and 10C shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described may be employed for providing a self-powered, trailer safety lighting system 10A, 10B and 10C in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way

What is claimed:

1. A device for supplying power to the lights of a towed vehicle or trailer, comprising: a battery, an in-line fuse, a flasher circuit, one or more lights, a means of removably connecting the battery to the one or more lights, a means of removably connecting the battery to the towed vehicle or trailer, where, the one or more lights are not connected to any electrical systems in a towing vehicle, and the one or more lights do not derive any power from the towing vehicle, and where the battery can be easily removed and transported from one location on the towed vehicle or trailer to another location on the towed vehicle or trailer, and where the battery can be easily removed and transported from one towed vehicle or trailer to another towed vehicle or trailer.

2. The device of claim 1, where, the means of connecting the battery to the one or more lights is one or more wires.

3. The device of claim 1, where the means of connecting the battery to the one or more lights is a one or more wires terminating in a plug which mates into a plug which leads to the one or more lights, and where the one or more lights are lights attached to a trailer or other towed vehicle.

4. The device of claim 3 where, the means of connecting the battery to the one or more lights is of set of four wires terminating in a 4-way, flat or round trailer connection plug which mates into a 4-way, flat or round towing vehicle connection plug which leads to the one or more lights.

5. The device of claim 3 where, the means of connecting the battery to the one or more lights is of set of five wires terminating in a 5-way, flat or round trailer connection plug which mates into a 5-way, flat or round towing vehicle connection plug which leads to the one or more lights.

6. The device of claim 3, where, the means of connecting the battery to the one or more lights is of set of six wires terminating in a 6-way, flat or round trailer connection plug which mates into a 6-way, flat or round towing vehicle connection plug which leads to the one or more lights.

7. The device of claim 3, where, the means of connecting the battery to the one or more lights is of set of seven wires terminating in a 7-way, flat or round trailer connection plug which mates into a 7-way, flat or round towing vehicle connection plug which leads to the one or more lights.

8. The device of claim 1, where, the means of removably connecting the battery to the towed vehicle or trailer is one or more straps.

9. The device of claim 1, where, the means of removably connecting the battery to the towed vehicle or trailer is one or more bolts with butterfly nuts.

10. The device of claim 1, additionally comprising a means of turning on and off the one or more lights such that a user of the invention can selectively turn on or off the one or more lights.

11. The device of claim 10, where the means of turning on and off the one or more lights is a toggle switch.

12. The device of claim 11, where the toggle switch is located adjacent to the battery.

13. The device of claim 11, where the toggle switch is located along one of the one or more wires in between the battery and the trailer lights, such that the toggle switch can be located in a location convenient for a user to reach to activate the device.

14. The device of claim 1, where the battery is contained in a box which is water resistant.

15. The device of claim 14, where the box can be removably mounted on the front hitch portion of the trailer or towed vehicle.

16. The device of claim 14, where the box can be removably mounted to the rear bumper of the trailer or towed vehicle.

17. The device of claim 1, where the one or more lights are the existing lights on the towed vehicle or trailer.

18. The device of claim 1, where the one or more lights is a light bar which comprises one or more LED (light emitting diodes).

19. The device of claim 1, additionally comprising a light bar, which comprises one or more LED (light emitting diodes) connected to the device by one or more wires, where the light bar is attached to the battery.

20. The device of claim 1, additionally comprising a light bar, which comprises one or more LED (light emitting diodes) connected to the device by one or more wires, where the light bar has a means of attachment such as bolts or straps, such that the light bar can be mounted in a location not adjacent to the battery.

21. The device of claim 1, where the battery has a solar charging element such that the battery charges itself whenever exposed to sunlight.

22. The device of claim 1, additionally comprising a second wire leading to a plug end which can connect to the cigarette lighter of a towing vehicle, thereby providing both an alternative and additional source of power to the one or more lights.

23. A method of detaching a trailer or other towed vehicle from a towing vehicle whereby the lights of the trailer or other towed vehicle are maintained in an operational manner, comprising the steps of: first, obtaining a device for supplying power to the lights of a towed vehicle or trailer, comprising: a battery, an in-line fuse, a flasher circuit, one or more lights, a means of removably connecting the battery to the one or more lights, a means of removably connecting the battery to the towed vehicle or trailer, where, the one or more lights are not connected to any electrical systems in a towing vehicle, and the one or more lights do not derive any power from the towing vehicle, and where the battery can be easily removed and transported from one location on the towed vehicle or trailer to another location on the towed vehicle or trailer, and where the battery can be easily removed and transported from one towed vehicle or trailer to another towed vehicle or trailer, where, the means of connecting the battery to the one or more lights is one or more wires, and, where the means of connecting the battery to the one or more lights is a one or more wires terminating in a plug which mates into a plug which leads to the one or more lights, and where the one or more lights are lights attached to the towed vehicle or trailer; second, attaching the device to towed vehicle or trailer and plugging the plug attached to the battery into the mating plug attached to the towed vehicle or trailer; and third, turning on the device.
